(19) United States
(12) Patent Application Publication
(10) Pub. No.: US 2025/0250651 A1
(43) Pub. Date: Aug. 7, 2025

(54) ELECTRIC STEEL WITH TENSION COATING LAYER, AND METHOD OF PRODUCING THE SAME

(71) Applicant: UNIVERSITY COLLEGE CARDIFF CONSULTANTS LTD., Cardiff (GB)

(72) Inventors: Philip Rosser DAVIES, Cardiff, South Glamorgan (GB); Philip lan ANDERSON, Cardiff, South Glamorgan (GB); Lee Eric EDWARDS, Cardiff, South Glamorgan (GB)

(21) Appl. No.: 18/854,928

(22) PCT Filed: Apr. 11, 2023
(86) PCT No.: PCT/GB2023/050951

§ 371 Date: Oct. 7, 2024

(30) Foreign Application Priority Data
Apr. 11, 2022 (GB) 2205286.4

(51) Int. Cl. C21D 8/12; C01B 32/23; C23C 22/20

(52) U.S. Cl. CPC C21D 8/1288; C01B 32/23; C23C 22/20

(57) ABSTRACT

A method of producing a coated electrical steel is described. The method comprises: providing an electrical steel substrate; providing a coating composition, said coating composition comprising silica particles, metal phosphate, and a graphitic oxide; applying the coating composition to at least a portion of the electrical steel substrate; and subjecting the coating composition to at least one curing treatment to form a tension coating layer.

The present invention relates to a method of producing a coated electrical steel. The present invention also relates to a coated electrical steel, an electrical transformer comprising a coated electrical steel, and uses of a coated electrical steel.

### BACKGROUND

Electrical steels have important electrical application thanks to their specific magnetic properties. For example, grain oriented electrical steels are widely used in electrical transformers for transforming alternating current generated by power station turbines, renewable turbines or solar power and other means, to enable efficient transmission from the energy source to the point of end use. This is a rapidly expanding market in view of developments in alternative energy sources, and increased energy demand. The global market for grain oriented electrical steels is currently circa 3.0 million tonnes. With regard to non-grain oriented electrical steels, these may be applied in rotating equipment such as electric motors and generators. However, electrical steels suffer from significant energy losses and magnetostriction.

In order to minimise the effects of magnetostriction, coatings comprising magnesium and/or aluminium phosphate coatings incorporating silica suspensions have previously been applied to electrical steel. However, the presence of toxic and carcinogenic chromium in the hexavalent state in such coatings means that they are no longer acceptable for safety reasons.

In the absence of chromium, a coating comprising a metal phosphate and silica is known to show poor loss control and suffer from poor visual appearance.

There is an a priori need for an improved coating for electrical steel that can mitigate the above problems.

### BRIEF DESCRIPTION OF FIGURES

Various aspects of the invention are described, by way of example, with reference to the accompanying figures, in which:

FIG. 1 shows a coating apparatus for use in embodiments of the present invention.

FIG. 2 shows magnetostriction results for a steel, coated with a commercial tension coating composition.

FIG. 3 shows magnetostriction results for a steel coated with a coating composition in accordance with an embodiment of the present invention.

FIG. 4 shows XPS spectra for a graphitic oxide for use in a coating composition in accordance with an embodiment of the present invention.

### DESCRIPTION

Before particular examples of the present invention are described, it is to be understood that the present disclosure is not limited to the particular steels, methods or materials disclosed herein. It is also to be understood that the terminology used herein is used for describing particular examples only and is not intended to be limiting, as the scope of protection will be defined by the claims and equivalents thereof.

In describing and claiming the coating, steel and method of the present invention, the following terminology will be used: the singular forms “a”, “an” and “the” include plural forms unless the context clearly dictates otherwise. Thus, for example, “a steel strip” includes reference to one or more of such elements.

According to one aspect of the present invention, there is provided a method of producing a coated electrical steel comprising:
(i) providing an electrical steel substrate;
(ii) providing a coating composition, said coating composition comprising silica particles, metal phosphate, and a graphitic oxide;
(iii) applying the coating composition to at least a portion of the electrical steel substrate; and
(iv) subjecting the coating composition to at least one curing treatment to form a tension coating layer.

According to another aspect of the present invention, there is provided a coating for an electrical steel; said coating comprising a matrix comprising a metal phosphate and silica, and wherein the coating further comprises graphitic oxide present in an amount of between 0.25 to 25 wt % of the tension coating layer.

According to another aspect of the present invention there is provided a coated electrical steel comprising a tension coating layer as detailed above.

According to another aspect of the present invention there is provided an electrical transformer comprising the coated electrical steel as detailed above.

According to another aspect of the present invention there is provided use of the coated electrical steel detailed above in an electrical transformer.

The present invention relates to a coating on a steel, for example an electrical steel. The present inventors have surprisingly found that formation of a coating layer on a steel, wherein the coating layer comprises a metal phosphate and silica, and wherein the coating layer further comprises graphitic oxide present in an amount of between 0.25 to 25 wt % of the layer, can provide certain advantageous properties.

The properties of a graphene-based material, such as an extremely high theoretical melting point of above 5000° C., can enable it to provide reinforcement of a phosphate/silica coating. In addition, inclusion of graphene-based material may enhance tensile strength and improve magnetic losses and magnetostriction. Without wishing to be bound by any theory, it is believed that use of an oxidised form of carbon, such as a graphitic oxide, within the coating composition can enable good dispersion into the metal phosphate and silica also present in the coating. While graphene is immiscible in water, increasing the amount of surface oxygen can enable better dispersion of graphene within a solution. This can aid dispersion of graphene in the coating composition, and can provide improved integration of graphene within the metal phosphate/silica matrix formed in the tension coating layer Improved chemical bonding may also be provided. Thus, a coated steel in accordance with the present invention may have graphitic oxide homogeneously dispersed within the tension coating layer, i.e. the graphitic oxide is homogeneously dispersed within a matrix of metal phosphate and silica particles. The inclusion of graphitic oxide in the coating composition may also provide bonding sites during curing.

In addition, the present invention avoids the need for including chromium within the tension coating layer, thus avoiding the risks associated with storage and handling of such compounds. In particular, the present invention allows the formation of a tension coating layer on an electrical steel that, in the absence of chromium, can provide properties such as a reduction in magnetostriction, improved compressive stress resistance, and improved magnetic loss control.

The tension coatings of the present invention may also provide improved visual appearance over comparable coatings. A coating layer that comprises metal phosphate and silica may have a poor and uneven appearance when applied to a steel substrate. To mitigate such an uneven appearance, which may result from white patches of concentrated SiO₂, or areas of high coating concentration due to poor wetting resulting from the absence of a chromium additive, a coating composition of metal phosphate and silica may be applied sparingly. However, a sparse coating may result in increased magnetic losses, and may only provide limited protection to the steel substrate. Without wishing to be bound by theory, the inclusion of graphitic oxide may enable an optimum coating thickness to be applied, and thus may reduce magnetic losses and may provide increased protection of the steel. The presence of a carbon material, such as graphitic oxide, within a coating may also darken and thus improve the appearance of the coating layer.

The invention relates to formation of a coating on a metal substrate, for example a steel substrate. Preferably, the steel is an electrical steel selected from a grain oriented electrical steel, or a non-grain oriented electrical steel. Electrical steel is an iron alloy which has been processed, through a combination of cold rolling and heat treatments, to create laminations with favourable magnetic properties. Electrical steel typically contains up to 3.2 wt % silicon and typically has extremely low levels of carbon e.g. 0.005 wt % or lower. Electrical steel provides certain magnetic properties which, in grain oriented electrical steel, are largely present within a particular direction in the steel as a result of manufacturing controls. In non-grain oriented electrical steel, magnetic properties are similar in all directions throughout the steel. The steel substrate may take the form of a flat steel substrate, for example a steel sheet or steel strip. Preferably, for example in the case of electricity transformers, the steel substrate is a grain oriented electrical steel sheet or strip. Alternatively, the steel substrate may be a non-grain oriented electrical steel sheet or strip. A steel strip may have a thickness of from 0.1 to 1 mm, preferably from 0.2 to 0.8 mm, for example from 0.3 to 0.5 mm. In an embodiment, the electrical steel has a layer of a glass film which typically consists of a magnesium silicate, such as forsterite (Mg₂SiO₄), on the surface. This silicate layer may be formed during annealing of the steel, and may result from the reaction of added magnesium oxide, silicon and iron oxides, and is formed directly on the surface of the steel.

A tension coating layer may be formed on one side of the steel substrate, or on both sides. Preferably, the entirety of the steel substrate may be coated. In an embodiment, the tension coating layer is formed on a forsterite layer that is present on the surface of the steel substrate, preferably on both surfaces of the steel substrate. In another embodiment, the tension coating layer is formed directly on the steel substrate. The tension coating layer may have a thickness of between 1 and 12 μm, preferably between 2 and 10 μm, for example between 4 and 8 μm. The thickness of the tension coating layer is sufficient to impart improved magnetic properties to the coated steel, without increasing thickness of the steel to an undesirable extent. The thickness is a dry film thickness and may be measured by any suitable method, for example by using a thickness gauge (such as a Fischer FMP30 Deltascope).

In an embodiment, the coating layer is substantially chromium free, for example comprises less than 0.1 wt % chromium, preferably less than 0.05 wt % chromium.

In the method of the present invention, a coating composition comprising a metal phosphate, silica particles and a graphitic oxide is applied to the steel substrate. The coating composition may take the form of an aqueous solution. A single metal phosphate, or a mixture of metal phosphates may be included in the composition. The metal phosphate may be selected from aluminium phosphate, magnesium phosphate, zinc phosphate or a mixture thereof. In one embodiment, the metal phosphate is an orthophosphate. Preferably, the metal phosphate is aluminium phosphate, such as aluminium orthophosphate, for example aluminum tris(dihydrogen orthophosphate) (Al(H₂PO₄)₃). In another embodiment, the metal phosphate may comprise a mixture of aluminium phosphate and magnesium phosphate. The metal phosphate may be included in the coating composition in an amount of from 30 to 70 wt % of the coating composition, preferably from 40 to 60 wt %, for example from 45 to 55 wt % of the coating composition. The metal phosphate may be obtained commercially or may be prepared by any suitable method. In one embodiment, the metal phosphate is an aluminium phosphate, for example Al(H₂PO₄)₃. In one example, Al(H₂PO₄)₃ may be prepared by reaction of Al(OH)₃ and H₃PO₄.

The coating composition further comprises silica particles. In an embodiment, the silica particles comprise colloidal silica. The silica particles may be present in an amount of from 10 to 70 wt % of the coating composition, preferably from 20 to 60 wt %, for example from 40 to 50 wt % of the coating composition. The silica particles may have an average particle size of from 1 to 25 nm, preferably from 5 to 15 nm, for example from 8 to 12 nm. By “particle size”, this refers to the particle diameter in the case of a substantially spherical particle or, in a non-spherical particle, can refer to the longest dimension of that particle. The “average particle size” may refer to the D50 particle size, i.e. the particle size at the 50^{th} percentage, i.e. 50% of the particles (by number) have a greater particle size and 50% of particles (by number) have a smaller particle size. The particle size may be presented as a Gaussian or Gaussian-like distribution. Particle size may be measured by any suitable method, for example by electron microscopy (e.g. TEM). The silica particles may have an average specific surface area of from 200 to 800 m²/g, preferably from 300 to 500 m²/g, for example from 320 to 400 m²/g. The specific surface area may be determined by any suitable method, for example BET.

In one embodiment, the coating composition comprises aluminium phosphate and colloidal silica, preferably colloidal silica having an average particle size of from 1 to 25 nm.

Any suitable form of graphitic oxide may be included. “Graphitic oxide” refers to a compound comprising carbon, oxygen and hydrogen.

A commercially available form of graphitic oxide may be used. Alternatively, graphitic oxide may be provided by oxidation of a suitable form of carbon, such as a graphene or graphite material. For example, a carbon material in the form of graphene nanoplatelets may be oxidised to form a graphitic oxide. Graphene nanoplatelets may include up to 100 layers of graphene. In another example, the carbon material may be few layered graphene (consisting of 3 to 10 layers of graphene). A graphite material may also be oxidised to form graphitic oxide, for example a graphite material in the form of graphite flakes or powder. Other forms of carbon material may also be contemplated, such as carbon nanotubes.

The particles of graphene material or graphite material may have an average surface area of from 50 to 800 m² g⁻¹, preferably from 100 to 300 m² g⁻¹, for example from 150 to 250 m² g⁻¹. The surface area is determined by any suitable method, for example BET. Selection of a graphene material such as graphene nanoplatelets or few layered graphene, with a high surface area, i.e. relatively small particle size, may avoid potential short circuits occurring through the laminations of a transformer core, in view of the thickness (e.g. 6 μm) of the coating layer.

The graphene or graphite material may have an average particle size of from 300 nm-15 μm, preferably from 1-10 μm, for example from 3 to 6 μm. By “particle size”, this refers to the particle diameter in the case of a substantially spherical particle or, in a non-spherical particle, can refer to the longest dimension of that particle. The “average particle size” may refer to the D50 particle size, i.e. the particle size at the 50^{th} percentage, i.e. 50% of the particles (by number) have a greater particle size and 50% of particles (by number) have a smaller particle size. The particle size may be presented as a Gaussian or Gaussian-like distribution. Particle size may be measured by any suitable method, for example by electron microscopy (e.g. TEM).

Any suitable method of oxidation may be employed. For example, a chemical oxidation method may be used in which the graphene or graphite may be treated with one or more oxidising agents. Any suitable oxidising agent, or combination thereof, may be used. In one embodiment, oxidation may be performed using one or more oxidising agents in combination with one or more organic acids. The oxidising agent may be a salt such as a permanganate, for example potassium permanganate, or a chlorate such as potassium chlorate. The organic acid may be selected from nitric acid, sulfuric acid, hydrochloric acid and combinations thereof. Oxidation may be performed at a low temperature, for example by cooling the reaction mixture to below 10° C., for example below 5° C. Exemplary oxidation methods include the Staudenmaier, Tours, Hummers, Brodie or Hofmann methods.

A preferred method of oxidising a graphene or graphite material is the Hummers method, or a modified version of the Hummers method. In one embodiment, oxidation of graphene or graphite is performed by treatment with a combination of sulfuric acid and nitric acid, potassium permanganate, and hydrogen peroxide. Oxidation may be carried out below room temperature, for example in an ice bath. For example, following treatment of the carbon material with sulfuric acid and nitric acid, the reaction mixture may be cooled to below 10° C., for example below 5° C. Following addition of potassium permanganate, the reaction mixture may be cooled to between 0 and 5° C.

In a preferred embodiment, graphitic oxide is prepared by combining graphene or graphite with at least one organic acid selected from nitric, sulfuric and hydrochloric acids, and potassium permanganate; cooling the reaction mixture to between 0 and 5° C., adding hydrogen peroxide to the reaction mixture, and separating graphitic oxide from the reaction mixture. Addition of water to the reaction mixture may be performed before, during and/or after addition of the hydrogen peroxide.

Alternatively, oxidation of graphene or graphite may be performed by treatment with sulfuric acid, followed by the addition of potassium permanganate, maintaining the reaction mixture at a temperature of between 0° C. and 10° C., followed by addition of hydrogen peroxide and water to the reaction mixture. In this case, the Tours method may be followed.

Alternatively, oxidation of graphene or graphite may be performed by treatment with sulfuric acid in combination with nitric acid and potassium chlorate (KClO₃). This may follow the Staudenmaier method. Alternatively, treatment with nitric acid and potassium chlorate may be performed, for example in line with the Brodie method. As a further alternative example, treatment with sulfuric acid and nitric acid may be performed, for example following the Hofmann method.

Following oxidation, a slurry of graphitic oxide may be separated from the supernatant by, for example, centrifuging. The slurry of graphitic oxide may then be introduced into the coating composition. Alternatively, the slurry may be dried before use in the coating composition.

The graphene or graphite material may alternatively be oxidised using a non-chemical method. For example, graphitic oxide may be produced by plasma oxidation of graphene or graphite.

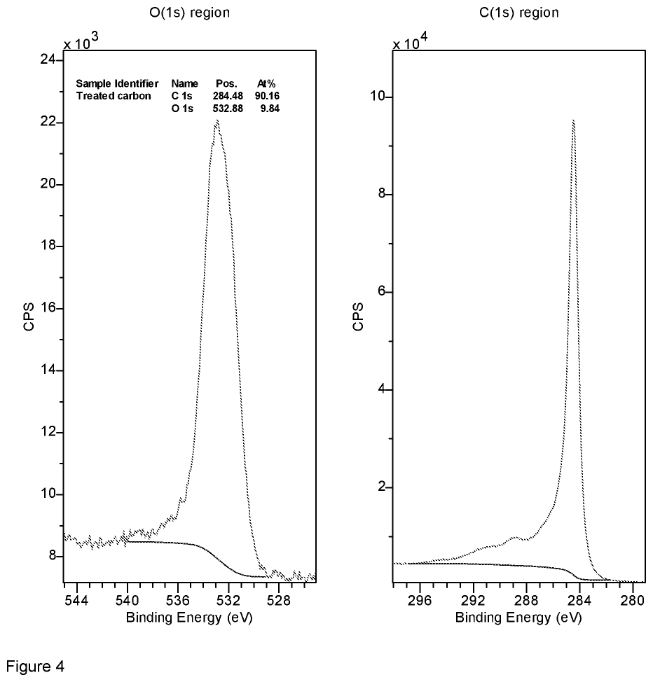

Oxidation of graphite or graphene, such as graphene nanoplatelets or few layered graphene, occurs by attachment of oxygen functional groups, such as epoxide, hydroxyl, carbonyl and carboxylate groups to the carbon material, in particular on the edges and surface defects of the carbon material. Depending on the oxidation method, other oxygen functional groups such as nitrate and sulfate groups may be formed. Surface defects may already be present on the carbon material, or may be created during oxidation. Prior to oxidation, the graphene/graphite carbon material may already include a small amount of oxygen on the surface (for example, 2 to 2.5% oxygen). Oxidation of a carbon material can provide graphitic oxide comprising oxygen in an amount of from 1 to 40 at %, preferably from 3 to 20 at %, for example from 5 to 15 at %. The amount of oxygen is based on the oxygen content of the graphitic oxide as a whole. However, the amount of oxygen generally varies throughout the graphitic oxide, namely more oxygen is found on the surface of the graphitic oxide. For example, the amount of oxygen at the surface of the graphitic oxide may be close to 100%. Any suitable method may be used to measure the extent of oxidation, for example X-ray photoelectron spectroscopy (XPS). See, for example, FIG. 4. X-ray fluorescence (XRF) and other bulk analysis techniques may also be used to determine the extent of oxidation.

The graphitic oxide may be present in a coating composition in an amount of from 0.25 to 25 wt % of the coating composition, preferably from 1 to 10 wt %, for example from 2 to 6 wt %. While individual layers of graphene are electrical conductors in the sp² plane, maintaining a graphitic oxide amount of below 30 wt % may prevent conduction within the tension coating layer, due to dispersion of the graphitic oxide within the metal phosphate/silica matrix. Similarly, maintaining an average graphitic oxide particle size of from 300 nm-15 μm, preferably from 1-10 μm, for example from 3 to 6 μm, may also help to mitigate conduction within the tension coating layer.

The coating composition may be formed by combining the silica particles, metal phosphate, and graphitic oxide.

In one embodiment, the silica particles and metal phosphate are mixed in solution, followed by addition of the graphitic oxide.

In a preferred embodiment, the coating composition comprises metal phosphate in an amount of from 30 to 70 wt %, colloidal silica in an amount of from 10 to 70 wt %, and graphitic oxide in an amount of from 0.25 to 25 wt % of the coating composition. In one embodiment, the coating composition comprises Al(H₂PO₄)₃ in an amount of from 40 to 60 wt %, colloidal silica in an amount of from 40 and 60 wt %, and graphitic oxide in an amount of from 1 to 10 wt % of the coating composition.

The coating composition may additionally contain other additives. In one embodiment, corrosion inhibitors may be included as an additive, in particular chromium-free corrosion inhibitors. Suitable corrosion inhibitors include inorganic compounds of V, Mo, Mn, Tc, Zr, Ce or mixtures thereof, for example sodium metavanadate, zirconium silicate and/or cerium intercalated clay. Corrosion inhibitors may be present in the coating composition in an amount of from 0.01 to 10 wt % of the coating composition, preferably from 0.1 to 5 wt %, for example from 0.5 to 1 wt %. Another example of an additive is soluble silicate, which may be present in an amount of between 0.01 and 5 wt %, preferably from 0.5 to 3 wt %, for example from 1 to 2 wt % of the coating composition. The coating composition may be an aqueous composition, i.e. the balance of the coating composition may be water.

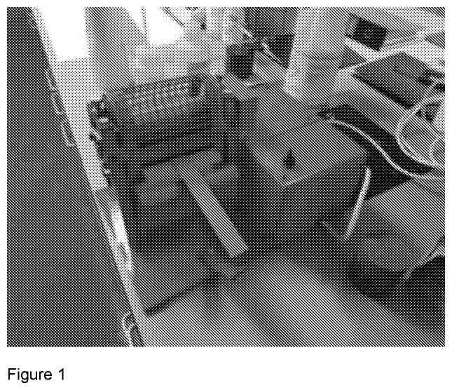

The coating composition may be applied to the steel substrate by any suitable method, for example roller coating. Preferably, the coating is applied in a continuous coating line. A coating line speed of at least 50 m/min, for example at least 100 m/min, such as between 140 and 180 m/min, may be used. The roller coating apparatus may comprise a series of rollers, for example two or more rollers. The substrate passes between the rollers and, as it passes between the rollers, is coated by the coating composition. An exemplary roller coating apparatus is shown in FIG. 1. The coating composition may be applied to the substrate once, or two or more times, for example between two and five times. Passing the substrate through a roller coating apparatus several times may ensure even application of the coating composition onto the substrate. Where the steel substrate has a forsterite layer on the surface of the steel, the coating composition is applied directly on the forsterite layer. The presence of the forsterite layer may be advantageous in improving adhesion of the coating composition to the substrate. Alternatively, the coating composition may be applied directly onto a steel substrate. Where the steel substrate is a steel strip or sheet, the coating composition may be applied to both sides of the strip. Alternatively, the coating composition may be applied to only one side of the strip or sheet.

Following application of the coating composition to the substrate, the coating composition is subjected to at least one curing treatment. Curing may be performed at a temperature above 500° C. In an embodiment, curing may be performed at a temperature from 750° C. to 1000° C., preferably between 800° C. to 950° C., for example between 850° C. and 900° C. The curing time may be determined from the appearance of the coating, which whitens upon curing. For example, the curing time may be between 5 and 30 seconds, for example from 8 to 15 seconds. The coated substrate may be placed in an oven at a temperature of from 95 to 120° C., for example from 100 to 110° C., before curing. This step may remove excess water before curing. The substrate may be placed in the oven from between 5 and 20 minutes, for example between 10 and 15 minutes.

Application of further layers onto the steel substrate may also be envisaged. For example, one or more insulating layers may be applied to the steel substrate, either directly onto the steel substrate itself, onto a forsterite layer, or onto the tension coating layer, or any combination thereof.

In accordance with an aspect of the invention, there is disclosed a coated electrical steel comprising a tension coating comprising a matrix comprising a metal phosphate and silica, and wherein the coating further comprises graphitic oxide present in an amount of between 0.25 to 25 wt % of the tension coating layer. Also disclosed is a coated electrical steel produced by the method described herein.

In the coated electrical steel in accordance with the present invention, the coating layer may have a thickness of between 1 and 12 μm, for example between 2 and 10 μm, for example between 4 and 8 μm. The tension coating layer may comprise metal phosphate in an amount of from 30 to 70 wt % of the tension coating layer, preferably from 40 to 60 wt %, for example from 30 to 50 wt %. The tension coating may comprise silica, for example colloidal silica, in an amount of from 10 to 70 wt % of the tension coating layer, preferably from 20 to 60 wt %, for example from 40 to 50 wt %. The graphitic oxide is present in the tension coating layer in an amount of from 0.25 to 25 wt % of tension coating layer, preferably from 1 to 10 wt %, for example from 2 to 6 wt %. The coated electrical steel may be a grain oriented electrical steel or a non-grain oriented electrical steel, as described herein.

The coated electrical steel in accordance with the present invention can have various electrical applications. In accordance with another aspect of the invention, there is disclosed an electrical transformer comprising the coated steel as described herein. Preferably, the electrical transformer comprises coated grain-oriented electrical steel. Alternatively, the coated electrical steel in accordance with the present invention may be included in an electric motor or a generator. In particular, a non-grain oriented electrical steel in accordance with the invention may be included in an electric motor or generator.

In accordance with another aspect of the invention, there is disclosed the use of the coated steel as described herein in an electrical transformer, in particular as a core material in an electrical transformer. Preferably, this coated steel is a grain-oriented electrical steel. In another aspect, use of a non-grain oriented electrical steel in an electric motor or generator, for example, is envisaged.

The coated steel disclosed herein may provide advantages over current steel coatings, for example over those that comprise metal phosphate and silica but do not comprise graphitic oxide. The coated steel disclosed herein may also provide advantages over steel coatings that comprise chromium.

The coating of the present invention may provide a decrease in magnetic loss. Magnetic loss testing may be performed using an Epstein frame tester, according to industry standard IEC 60404-2. The coating of the invention may also provide a reduction in magnetostriction. Magnetostriction is a property of ferromagnetic materials that causes expansion or contraction in response to a magnetic field which causes a reorganisation of the magnetic domain structure. This may result in an undesirable level of vibration (noise/humming) due to repeated expansion and contraction. Magnetostriction may be determined by measuring the vibration of a magnetised sample using a laser vibrometer or accelerometer. The stress sensitivity of magnetostriction may be determined by applying an external compression to the sample using a pneumatic cylinder or similar apparatus.

Without wishing to be bound by theory, it is believed that the structure of the tension coating of the present invention may enable magnetostriction to be reduced. It is understood that the tension coating holds the steel under tension, which negates the influence of harmful compressive stress. The coating of the present invention provides a higher tensile strength in comparison to other steel coatings, for example steel coatings that do not include graphitic oxide. As a result of the increased tension provided by the coating, it follows that magnetostriction may be reduced. In turn, this may reduce the amount of noise or humming generated by a transformer.

### EXAMPLES

### Example 1: Preparation of Graphitic Oxide

A version of the Hummers method was used to provide graphitic oxide in the form of oxidised graphene nanoplatelets. 5 g graphene nanoplatelets (Alfa Aesar; S. A. 500 m²/g) were gently stirred in an ice bath with 114 ml of a concentrated H₂SO₄ and HNO₃ mixture, (3:1) before 2 g of KMnO₄ was added stepwise. The sample was then heated to 35° C. for 30 minutes then placed back in ice before adding 250 mL H₂O gently over 15 minutes. A further 1 L of H₂O was added before finally adding 100 mL 3% H₂O₂, stirring for 15 mins and standing overnight.

The material was washed with water until the resulting supernatant reached pH 7 to ensure removal of all sulphate.

### Example 2: Baseline Tension Coating Composition

The following baseline composition was used in the formulation of tension coating compositions.

| | Percentage | | | Solids |
|---|---|---|---|---|
| | of baseline | Quantity | Density | content |
| Chemicals | composition | mL | g/mL | Mass % |
| Chemetall | 36 | 180 | 1.465-1.485 | 48% |
| Gardobond Al | | | @ 15° C. | Al(H₂PO₄)₃ |
| (Aqueous | | | | |
| aluminium tris | | | | |
| dihydrogen | | | | |
| orthophosphate) | | | | |
| Ludox SM-30 | 56 | 260 | 1.22 @ | 30% SiO₂ |
| (Colloidal | | | 25° C. | |
| Graphsilica) | | | | |
| Deionised water | 8 | 40 | 1@ 25° C. | 100% H₂O |

### Example 3: Carbon Tension Coating Composition

Coating composition comprising the graphitic oxide of Example 1 was prepared as follows. Chemetall Gardobond AL (Aluminum tris(dihydrogen phosphate) contains 48% by mass Al(H₃PO₄)₃. This was derived directly from Al(OH)₃ and H₃PO₄.

Al(OH)₃+3H₃PO₄→exothermic→Al(H₂PO₄)₃

Aluminium hydroxide (Al(OH)₃) (e.g. Sigma-Aldrich, Reagent Grade) was mixed with was mixed with H₃PO₄ (Sigma-Aldrich, 85% wt, 99.99% purity) with varying amounts of water depending on the application (gel or tension coating). The reaction is exothermic and it is recommended to add water first, then the H₃PO₄ stepwise while stirring, then stir until clear. The amount of water was controlled to ensure that the total water used was the same mass as in the Gardobond defined above in relation to the baseline composition. 48% mass Al(H₂PO₄)₃ was then cooled until completely clear and stored until required.

Grace Ludox SM-30 (Si 30%, pH 9.7-10.4, average particle size 8 nm, % Na₂O 0.018-0.027) colloidal silica filler was used.

The aluminium orthophosphate and colloidal silica were mixed in a ratio as defined in the baseline composition above, and mixed thoroughly for an hour. 10% (by mass of the total solid mass i.e. aluminium orthophosphate, colloidal silica and graphitic oxide) oxidised graphene nanoplatelets as prepared in Example 1 was added, and stirred for a further two hours.

### Example 4: Preparation of Steel Samples

Fully coated 0.27 mm HiB grain oriented electrical steel (GOES) was provided in the form of industry standard Epstein strips (305 mm×30 mm) (Cogent Power). 100 Epstein samples were cut each time from a large single sheet of GOES to ensure consistency of material. The Epstein samples were boiled in 20% NaOH for 10 minutes to dissolve the original aluminium phosphate/silica tension coating. The sample surface was wiped to remove the tension coating residue. The forsterite layer underneath remained unaffected and remained on the steel. The Epstein samples were then put through a stress relief anneal (SRA) in a furnace at a programmed ramp rate up to and held at 850° C. for 4 hours in nitrogen with 3% hydrogen. The Epstein samples were then subjected to magnetic loss and magnetostriction testing at 50 Hz, 1.7 T to enable a baseline comparison with strips coated with the carbon tension coating composition, after coating, curing and stress relief anneal.

### Example 5: Coating of Steel Samples

The coating apparatus is shown in FIG. 1. The coating apparatus consists of a bath that contains the coating composition, two stacked rollers with grooves to retain coating, a safety guard, and an electric motor. The motor drives the bottom roller and the top roller is the slave roller.

During coating, the Epstein samples were initially wiped (with the coating composition) to ensure cleanliness, and were then passed through the coater several times to provide an even tension coating layer. The coating composition was that prepared in accordance with Example 3. Once applied to the Epstein samples, the coating was approximately 8 μm thick on each side.

The Epstein samples were then put in an oven for 10 minutes at 100° C. to drive off excess water. They were then placed inside a preheated furnace set at 800° C. and carefully held inside long enough for the coating to cure. Curing was generally achieved in around 10 seconds, as evidenced by the coating whitening upon curing. The cured samples were then stacked in a mesh tray, and were then subjected to a stress relief anneal.

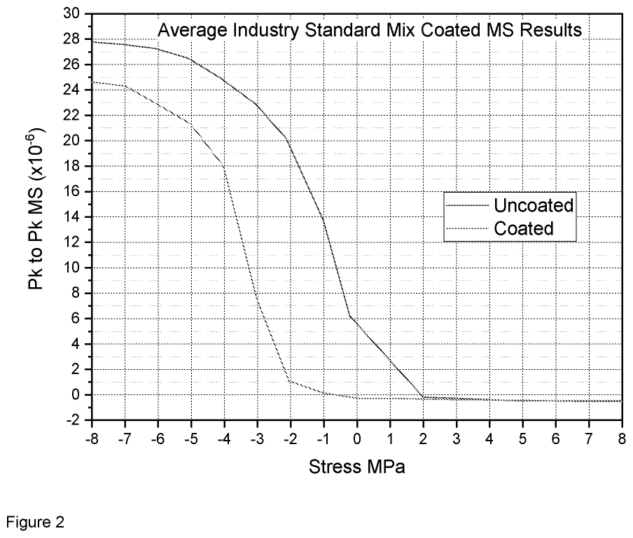

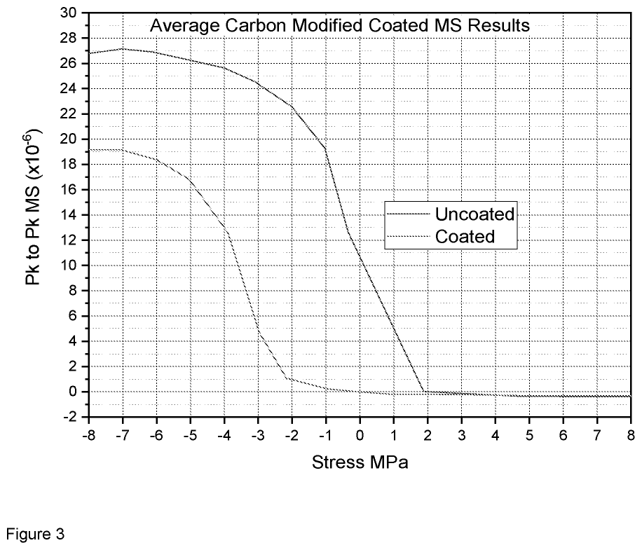

FIG. 2 shows average magnetostriction results for an Epstein sample coated with the baseline coating composition of Example 2, and of an Epstein sample prior to coating. FIG. 3 shows average magnetostriction results for an Epstein sample coated with the carbon tension coating composition of Example 3, and of an uncoated sample. A clear improvement in compressive stress resistance and peak to peak magnetostriction (×10⁻⁶) is demonstrated by the sample coated with a carbon tension coating in accordance with the invention.

The following table illustrates the improvement in magnetic loss, resistance to compressive stress, and magnetostriction of the coated sample of Example 3 over the baseline coating composition of Example 2.

| | Average % | | |
|---|---|---|---|
| | Improvement | Average MPa | Average MS (Pk |
| | Magnetic Loss | Improvement | to pk ×10e−6) % |
| | (W/kg) at | at 50 Hz | Improvement at |
| | 50 Hz 1.7 T | 1.7 T | 50 Hz 1.7 T |
| GNP-GO coating | 13.6 | 4.0 | 19.4 |
| formulation | | | |
| (Example 3) | | | |
| Baseline | 9.9 | 2.5 | 10.1 |
| coating | | | |
| (Example 2) | | | |

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of producing a coated electrical steel comprising:
i) providing an electrical steel substrate;
ii) providing a coating composition, said coating composition comprising silica particles, metal phosphate, and a graphitic oxide;
iii) applying the coating composition to at least a portion of the electrical steel substrate; and
iv) subjecting the coating composition to at least one curing treatment to form a tension coating layer.

2. The method of claim 1 wherein the metal phosphate is aluminium phosphate, magnesium phosphate, or a mixture thereof.

3. The method of claim 1 or claim 2, wherein the metal phosphate is present in an amount of from 30 to 70 wt % of the coating composition, for example from 40 to 60 wt %.

4. The method of any preceding claim wherein the silica particles comprise colloidal silica present in an amount of from 10 to 70 wt % of the coating composition, for example from 40 to 60 wt %.

5. The method of any preceding claim wherein the average particle diameter of the silica particles is from 1 to 25 nm, for example from 5 to 15 nm.

6. The method of any preceding claim, wherein the graphitic oxide is present in an amount of from 0.25 to 25 wt % of the coating composition, for example from 1 wt % to 6 wt %.

7. The method of any preceding claim, wherein the graphitic oxide is formed by the oxidation of graphene with an oxidising agent or oxidation method to form graphitic oxide, wherein the graphitic oxide comprises oxygen in an amount of from 1 to 40 at %, for example from 3 to 20 at %.

8. The method of any preceding claim wherein the graphitic oxide is prepared by combining graphene or graphite with at least one organic acid selected from nitric, sulfuric and hydrochloric acids; and potassium permanganate to form a reaction mixture; cooling the reaction mixture to between 0 and 5° C., adding hydrogen peroxide to the reaction mixture, and separating graphitic oxide from the reaction mixture.

9. The method of claim 7 or claim 8, wherein the graphene is graphene nanoplatelets having a surface area of from 50 to 800 m² g⁻¹, for example from 100 to 300 m² g⁻¹; and wherein the graphene nanoplatelets have an average particle diameter of 300 nm-15 μm, for example from 1-10 μm.

10. The method of any preceding claim, wherein the electrical steel is a grain oriented electrical steel strip, or wherein the electrical steel is a non-grain oriented electrical steel strip.

11. The method of any preceding claim, wherein the method further comprises application of an insulating layer on the steel substrate, or on the tension coating layer.

12. A coating for an electrical steel; said coating comprising a matrix comprising a metal phosphate and silica, and wherein the coating further comprises graphitic oxide present in an amount of between 0.25 to 25 wt % of the tension coating layer.

13. A coated electrical steel comprising a tension coating layer comprising the coating of claim 12.

14. The coated electrical steel of claim 13 wherein the tension coating layer comprises metal phosphate in an amount of from 30 to 70 wt % of the tension coating layer, for example from 40 to 60 wt %.

15. The coated electrical steel of claim 13 or 14 wherein the tension coating layer comprises silica in an amount of from 10 to 70 wt % of the tension coating layer, for example from 40 to 60 wt %.

16. The coated electrical steel of any of claims 13 to 15 wherein the tension coating layer is formed by the application of a coating composition to an electrical steel substrate, said coating composition comprising silica particles, metal phosphate, and a graphitic oxide, followed by curing of the coating composition.

17. The coated electrical steel of any of claims 13 to 16 wherein the steel is a grain oriented electrical steel.

18. The coated electrical steel of any of claims 13 to 17 wherein the tension coating is substantially chromium-free.

19. The coated electrical steel of any of claims 13 to 18 wherein the coating layer has a thickness of between 1 and 12 μm, for example 4 and 8 μm.

20. The coated electrical steel of any of claims 13 to 19, wherein an insulation layer comprising forsterite is present between the steel and the tension coating layer.

21. An electrical transformer comprising the coated electrical steel according to any one of claims 13 to 20.

22. Use of the coated electrical steel according to any one of claims 13 to 20 in an electrical transformer.
